(19) United States
(12) Patent Application Publication
(10) Pub. No.: US 2024/0301977 A1
(43) Pub. Date: Sep. 12, 2024

(54) Connecting Device for Connecting a First Line End to a Second Line End

(71) Applicant: Flecotec AG, Badenweiler (DE)

(72) Inventor: Martin Koch, Neuenburg (DE)

(73) Assignee: Flecotec AG, Badenweiler (DE)

(21) Appl. No.: 18/549,759

(22) PCT Filed: Apr. 21, 2021
(86) PCT No.: PCT/EP2021/060365

§ 371 Date: Sep. 8, 2023

(30) Foreign Application Priority Data
Mar. 10, 2021 (DE) 10 2021 105 817.1

(51) Int. Cl. F16L 37/113; F16L 37/086; F16L 37/096; F16L 37/23

(52) U.S. Cl. CPC F16L 37/113; F16L 37/086; F16L 37/096; F16L 37/23

(57) ABSTRACT

The present invention relates to a connecting device (10) for connecting a first line end (12) to a second line end (14), wherein the first line end (12) has a flange-like radial first widening (16) with a first end face (18) and a first rear face (20), and the second line end (14) has a plurality of flange-like radial second widenings (22) each with a second end face (24) and a second rear face (26), wherein the second widenings (22) are separated from one another by interruption portions (84), and the connecting device (10) comprises a connecting ring (74) with a first closure face (76) and a plurality of second closure faces (70) which are separated from one another by passage portions (80), wherein the first closure face (76) can be brought into contact with the first rear face (20), and the second closure faces (78) can be brought into contact with the second rear faces (26) by virtue of the fact that the second widenings (22) are guided with an axial movement through the passage portions (80) and then a relative rotational movement is carried out between the connecting ring (74) and the first line end (12) and/or a relative rotational movement is carried out between the connecting ring (74) and the second line end (14). Moreover, the invention relates to a method and a connecting arrangement (85) for connecting a first line end (12) to a second line end (14) using such a connecting device (10).

### CROSS-REFERENCE TO RELATED APPLICATIONS

This application claims priority to German Patent Application No. DE 10 2021 105 817.1, filed on Mar. 10, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The present disclosure relates to a connecting device for connecting a first line end to a second line end.

So-called tri-clamps are known as standardised connection terminals to connect line ends, for example hose ends or line ends to one another or together. A tri-clamp is understood to mean a foldable connection terminal or terminal clamp with two axially spaced clamping flanges that can be aligned with each other at a slight angle such that a wedge-shaped annular space, widening radially inwards, is formed between them. Such a tri-clamp is suited to aseptic assembly of two line ends, each of which comprises flange-like radial widenings, also known as contact flanges, arranged at their ends, and is in contact with each other via their respective end faces. The connection terminal is folded around the radial widenings, which abut one another, such that the clamping flanges are in contact with the respective rear faces of the radial widenings. The force applied to fold the connection terminal is deflected via the sloping faces of the clamping flanges into an axial force which acts as a contact force on the mutually abutting end faces of the radial widenings. In order to keep the connection terminal in the folded state, its free ends can be connected to one another. Screw connections are usually used for this purpose. Latch connections are provided for this purpose in U.S. Pat. No. 8,328,457 B2 and DE 10 2016 108 905 AI.

A disadvantage of using tri-clamps is that they are relatively hard to close and open again. It is particularly time-consuming if just one person has to close or open a tri-clamp. The excessive time required is particularly disadvantageous if the lines that need to be connected using a tri-clamp have to be cleaned frequently, requiring the tri-clamp to be opened.

If the lines that are connected to one another using a tri-clamp are used to transport toxic substances, particularly in particle form, it must be ensured that no or only very small quantities of these toxic substances are able to pass into the environment. So-called secondary interfaces are used for this purpose, with which tubular sheaths, usually made from a plastic film, are connected to one another and with which the tri-clamps are enclosed. In this case, however, the tri-clamps need to be opened and closed when the secondary interfaces are in the closed state, which makes handling even more difficult and further increases the time required.

### SUMMARY

An object of one embodiment is therefore to provide a connecting device for connecting a first line end to a second line end, with which it is possible, by simple and cost-effective means, to connect and subsequently detach a first line end and a second line end to or from one another in a simpler and quicker manner than when using a tri-clamp.

The object is addressed by the subject matter of the independent claims. Embodiments of the invention are described in the dependent claims, the following description, and the drawings.

### BRIEF DESCRIPTION OF THE DRAWINGS

FIG. 1A shows a first embodiment of a connecting device for connecting a first line end to a second line end, wherein the line ends are pre-positioned;

FIG. 1B shows the first embodiment of the connecting device represented in FIG. 1A in which the line ends are connected to one another;

FIG. 2A shows a second embodiment of the connecting device for connecting a first line end to a second line end;

FIG. 2B shows the second embodiment of the connecting device represented in FIG. 2A in which the line ends are pre-positioned;

FIG. 2C shows the second embodiment of the connecting device represented in FIG. 2A in which the line ends are connected to one another, by means of outline sectional views in each case;

FIG. 3A shows a third embodiment of the connecting device for connecting a first line end to a second line end, in which the line ends are pre-positioned;

FIG. 3B shows the third embodiment represented in FIG. 3A in which the line ends are connected to one another;

FIG. 4A shows a fourth embodiment of the connecting device for connecting a first line end to a second line end, in which the line ends are pre-positioned;

FIG. 4B shows the fourth embodiment represented in FIG. 3A in which the line ends are connected to one another;

FIG. 5 shows an outline plan view of the second embodiment of the connecting device;

FIG. 6A shows a first line end and a third embodiment of the connecting device in an initial state;

FIG. 6B shows the third embodiment illustrated in FIG. 6A in an intermediate state in which the connecting device is connected to the first line end;

FIG. 6C shows a second line end which can be connected to a first line end using the connecting device according to the third embodiment;

FIG. 6D shows the second line end illustrated in FIG. 6C which can be connected to a first line end using the connecting device according to the third embodiment;

FIG. 6E shows a further second line end which can be connected to a first line end using the connecting device according to the third embodiment;

FIG. 6F shows the further second line end illustrated in FIG. 6E which is connected to a first line end using the connecting device according to the third embodiment; and

FIG. 6G shows the second line end illustrated in FIG. 6D which is connected to a first line end using the connecting device according to the third embodiment, wherein the connecting device is enclosed by a secondary interface.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

One embodiment relates to a connecting device for connecting a first line end to a second line end, wherein
the first line end has a flange-like radial first widening with a first end face and a first rear face, and
the second line end has a flange-like radial second widening with a second end face and a second rear face, and the connecting device comprises:
a support ring, which can be brought into contact with the first rear face,
a locking device, which can be detachably connected to the support ring,
wherein, in the assembled state, the support ring or the locking device protrude axially over the first end face forming a receiving opening in which the second widening can be inserted, and
at least one locking body which is mounted in the support ring and/or in the locking device such that it can be moved in a radial direction, wherein
the locking body can be adjusted by means of the locking device between an open position, in which the second end face can be brought into contact with the first end face, and a closing position, in which the locking body applies an axial clamping force onto the second rear face such that the second end face is pressed against the first end face.

By virtue of the fact that the proposed connecting device comprises a support ring and a locking device that can be connected to said support ring, the connecting device can be pre-installed such that only the second line end needs to be inserted in the receiving opening and then the locking body needs to be moved radially. In this manner, it is significantly simpler to connect and subsequently detach both line ends to and from one another than when using tri-clamps, with the result that the connection operation can now also be performed by just one person without further ado. The time required for this operation is also significantly less than when using tri-clamps. The proposed connecting device is particularly suitable when the first line end and the second line end have identical designs.

According to an embodiment, the locking device may surround the support ring in an annular manner. In this embodiment, the locking device may be designed to be annular and thus rotationally symmetrical, which enables manufacturing costs to be minimised. In addition, the locking device is in contact with the support ring over its entire circumference, which means that a favourable force flux is achieved between the support ring and the locking device.

According to an embodiment, the support ring may be formed by at least two ring segments, which are connected together such that they can be detached, wherein the ring segments end radially flush with the first widening or protrude radially outwards over the first widening. In the event that two ring segments are provided, these may be designed as half-ring segments and thus have an identical design. The use of ring segments is particularly appropriate if the two line ends to be connected are each connected securely to other components, for example containers or ports. As a result, there is no free end by means of which the support ring can be pushed onto the line. However, in the two-part or multi-part embodiment of the support ring, it is possible to arrange this ring around the relevant first line. In this respect, in this embodiment, the connecting device can even be used if the first line is securely connected to other components.

In an embodiment, the locking device can be screwed onto the support ring. Screwing on is a comparatively simple operation. In addition, the locking device can be moved axially with respect to the support ring into the required position in which the locking device also remains if the relevant person lets go of the locking device. This makes it simpler to connect and detach the two line ends by simple technical means.

In an embodiment, the locking body can be mounted in the locking device such that it can be displaced in the radial direction and the second rear face may comprise a second inclined surface that is inclined with respect to the second end face, wherein the locking body applies the clamping force to the second inclined surface. As mentioned initially, many line ends already have inclined surfaces of this kind, particularly if they are used for chemical or biotechnological applications, with the result that these can be connected to one another with the tri-clamps mentioned initially, which are also used with the proposed connecting device. In this embodiment, the locking body can be mounted by simple technical means and yet the two line ends can be pressed against one another with a sufficiently high clamping force to allow them to be connected to one another in a sealing manner.

In an embodiment, the locking device comprises
a first ring that can be detachably connected to the support ring, and
a second ring, which is connected to the first ring such that it can rotate and is axially fixed, wherein the second ring interacts with the locking body by means of an adjustment surface and said adjustment surface is located a variable distance from or along the axis of rotation of the second ring.

The adjustment surface may either be a variable distance from the axis of rotation of the second ring or a variable distance along the axis of rotation of the second ring.

In the event that the adjustment surface is a variable distance from the axis of rotation of the second ring, the locking body can be displaced radially inwards to a greater or lesser extent, and vice versa, by a rotational movement of the second ring. As, however, the second ring is not moved axially during rotation, the connecting device according to this embodiment can also be used if there is very little axial space around the connecting device. In this embodiment, it is possible to connect the first ring to the support ring such that it cannot rotate.

In the event that the adjustment surface is a variable distance along the axis of rotation of the second ring, the locking body can be displaced radially inwards to a greater or lesser extent, and vice versa, by an axial movement of the second ring.

According an embodiment, the locking body can be pre-tensioned against the adjustment surface with a first pre-tensioning means. By virtue of the fact that the locking body is pre-tensioned against the adjustment surface, this ensures that the adjustment surface always remains in contact with the locking body. In particular, this ensures that the locking body moves radially outwards to detach the two line ends from one another.

In an embodiment, it may be beneficial for the locking body to be pre-tensioned radially inwards using a second pre-tensioning means. In the event that the locking body is pre-tensioned with both the first pre-tensioning means and the second pre-tensioning means, the pre-tensioning force of the second pre-tensioning means is selected to be lower than the pre-tensioning force of the first pre-tensioning means. Thus, as before, this ensures that the locking body abuts the adjustment surface. However, a rotation position of the second ring can also be provided in which the locking body does not abut the adjustment surface and therefore can be moved radially outwards by a certain amount against the pre-tensioning force of the second pre-tensioning means. As a result, the second line end can be pre-fixed so that the relevant person can remove their hands from the second line end. Only then, by rotating the second ring, is the locking body brought into contact with the adjustment surface and displaced radially inwards. This further simplifies connecting and detaching the line ends.

In an embodiment, the second ring can be manually rotated by means of a handle. The handle may, for example, be designed as a hand wheel or a lever such that the relevant person can conveniently turn the second ring without said person having to apply an excessive amount of force to allow the connecting device to provide a sufficiently high clamping force.

In an embodiment, the second ring can be rotated by means of a drive unit. A hydraulic cylinder or pneumatic cylinder or an electric drive may, for example, be used as a drive unit. As a result, connecting and detaching can be automated and simplified accordingly. It is also possible to record the connection and detaching operations in a substantially automated manner. Furthermore, the drive unit can be actuated such that a specific tightening torque and, accordingly, a corresponding clamping force, are provided. This thus ensures that the two line ends are not pressed together too tightly or too loosely.

One embodiment relates to a connecting device for connecting a first line end to a second line end, wherein
the first line end has
   a flange-like radial first widening with a first end face and a first rear face, or
   a plurality of flange-like radial first widenings, each with a first end face and a first rear face, wherein the first widenings are separated from one another by interruption portions, and
the second line end has a plurality of flange-like radial second widenings, each with a second end face and a second rear face, wherein the second widenings are separated from one another by interruption portions, and the connecting device
comprises a connecting ring with a radially peripheral first closure face and a plurality of second closure faces which are separated from one another by passage portions, wherein
the first closure face can be brought into contact with the first rear face, or the first closure faces can be brought into contact with the first rear faces, and
the second closure faces can be brought into contact with the second rear faces by virtue of the fact that the second widenings are guided with an axial movement through the passage portions and then a relative rotational movement is carried out between the connecting ring and the first line end and/or a relative rotational movement is carried out between the connecting ring and the second line end.

The closure ring on the first closure face is designed such that it can be brought into contact with the first rear face over a large area, while the closure ring comprises a number of second closure faces to provide a bayonet-like connection with the second widenings of the second line end. In this configuration of the connecting device, the first widening may be designed, as standard, in the form of a contact flange, as required when using commercially available tri-clamps, while the second line end is designed in the form of a bayonet. Accordingly, to connect and detach the two line ends, only one axial movement is required along the longitudinal axis defined by the first line end followed by a rotational movement around the longitudinal axis, with the result that connecting and detaching can take place in a very simple and rapid manner.

It should be noted at this point that two line ends can also be connected to one another using the connecting device according to the present configuration if the first line end has a plurality of flange-like radial widenings that are separated from one another by means of interruption portions. In this respect, the present connecting device can be used flexibly.

Furthermore, the connecting ring may either have a continuous first closure face or a plurality of first closure faces. In the latter case, the first closure faces are separated from one another by means of passage portions. The closure ring can then be constructed to be symmetrical.

In an embodiment, it can be provided that the connecting ring is formed by two or more ring segments. In the event that two ring segments are provided, these may be designed as half-ring segments and thus have an identical design. Even if more than two ring segments are provided, these can be designed to be identical. The use of ring segments is particularly beneficial if the two line ends to be connected are each connected securely to other components, for example containers or ports. As a result, there is no free end by means of which the connecting ring could be pushed onto the line connected to the first line end. However, in the two-part or multi-part embodiment of the connecting ring, it is possible to arrange this ring around the relevant first line. In this configuration it is also possible to connect two line ends having uninterrupted radial widenings to one another. However, connection in the form of a bayonet closure is not possible in this case.

An embodiment may allow the ring segments to be connected to one another by means of a cable tie. Cable ties are a mass-produced item that can be purchased economically. Furthermore, cable ties are very easy to use and reliable in operation. Alternatively, the ring segments can be connected to one another by means of a clip-on connection or snap-on connection.

According to an embodiment, the second closure faces and/or the second rear faces are inclined in the circumferential direction. Due to the inclination of the second closure faces and/or the second rear faces, when rotating the second line end, its rotational movement can also be converted to an axial movement such that the second line end is moved towards the first line end, causing a specific contact force to be provided between the two line ends and allowing these to be connected to one another in a sealing manner.

An embodiment provides for the connecting ring to be manufactured from a thermoplastics material. Nylon or polyethylene (PE) are particularly suitable as thermoplastics materials. Usually, the first line end is securely connected to a container, in particular a reactor, and the material of the first line end is thus defined. The second line end, on the other hand, is frequently connected to a flexible package and/or a sack in which substances that are converted in the reactor are transported and stored. The two line ends are connected to one another to transfer substances into the reactor. In the case of flexible packages and sacks, disposal is an issue once they have been emptied. It has become apparent that incineration is the safest disposal method, especially when using toxic substances. In the event that the aforementioned thermoplastics are used, substantially residue-free incineration is possible. Accordingly, it is beneficial to manufacture the connecting ring from the aforementioned thermoplastics.

Furthermore, due to the comparatively simple geometric shape of the connecting ring, it is possible to manufacture this by the injection moulding method so that large quantities can be produced at low cost.

According to an embodiment, the connecting ring can be designed to complement a standard tri-clamp fitting. Standard tri-clamp fittings feature in standards such as ISO 2852 1993-06 (published in June 1993, since withdrawn) or DIN 31676 in the applicable version on the priority date. Being designed to complement these standard tri-clamp fittings is understood to mean that the connecting ring is designed to fit such fittings accordingly and, in parts, has a ‘female form’ to accommodate the standard tri-clamp fittings. Standard tri-clamps are frequently used, particularly in biotechnological and pharmaceutical applications. In this configuration the connecting device may be used for a large number of line ends. In an embodiment, it can be provided that the connecting device comprises a secondary interface that surrounds the connecting ring at a radial distance. With a secondary interface, tubular sheaths with which both line ends can be enclosed can be connected to one another. This significantly reduces the probability that toxic substances, in particular, will pass into the environment.

An embodiment relates to a method for connecting a first line end to a second line end using a connecting device according to any of the configurations described above, comprising the following steps:
bringing the first closure face of the connecting ring into contact with the first rear face of the first widening of the first line end,
passing the second widenings of the second line end through the passage portions, and
bringing the second closure faces of the connecting ring into contact with the second rear faces of the second widenings of the second line end by a relative rotational movement between the connecting ring and the first line end and/or by a relative rotational movement between the connecting ring and the second line end.

A further embodiment relates to a method for connecting a first line end to a second line end using a connecting device according to any of the configurations described above, comprising the following steps:
passing the first widenings of the first line end through the passage portions of the connecting ring,
bringing the first closure faces of the connecting ring into contact with the first rear faces of the first widenings of the first line end by a relative rotational movement between the connecting ring and the first line end,
passing the second widenings of the second line end through the passage portions of the connecting ring, and
bringing the second closure faces of the connecting ring into contact with the second rear faces of the second widenings of the second line end by a relative rotational movement between the connecting ring and the second line end.

The benefits and technical effects described for the connecting device can likewise be achieved with the two methods. It should be noted that the first line end and the second line end can be connected together in a quick and simple manner. Particularly if a secondary interface is used, the two line ends can be connected to and subsequently detached from one another without having to open the secondary interface, thus minimising the risk that the secondary interface or the associated tubular sheaths are damaged in the process.

The connecting ring is a component with a relatively simple design which can be manufactured correspondingly economically.

One embodiment relates to a connecting arrangement for connecting a first line end to a second line end using a connecting device according to any of the embodiments described above, comprising:
a first line end and a second line end and
a connecting ring, wherein
the first line end and the second line end can be or are connected to one another with the connecting ring.

The benefits and technical effects described for the connecting device can likewise be achieved with the connecting arrangement.

In an embodiment, the first line end and/or the second line end can be manufactured from a thermoplastics material.

As mentioned above, the use of a plastics material has benefits for disposal of the connecting ring. These benefits also arise in particular when using the line end connected to flexible packages or sacks. For this reason, it is beneficial to manufacture the second line end and the connecting ring from the same thermoplastic from which the flexible package or sack is also manufactured. In addition, the flexible package or sack can also be connected to the second line end by welding.

An embodiment provides that the first line end and/or the second line end are designed as a standard tri-clamp fitting. As mentioned, the standard tri-clamp fitting is frequently used, particularly in biotechnological and pharmaceutical applications. In this configuration, the connecting device may be used for a large number of line ends. It should be noted at this juncture that even versions of the first line end and the second line end should be regarded as standard tri-clamp fittings if they comprise a plurality of first widenings or second widenings respectively, which are separated from one another by interruption portions provided that they otherwise comply with standards ISO 2852 or DIN 31676, for example.

One application of the present teachings relates to the use of the connecting device according to any of the embodiments and configurations herein in the manufacture and transportation of biotechnological and pharmaceutical products. The benefits and technical effects described for the connecting device can likewise be achieved with the use. Particularly if the connecting device is operated with a secondary interface, the connecting device is also suitable for connecting line ends through which toxic substances are conveyed. In many cases, these are particulate substances wherein the substances can also be conveyed through the line ends in the liquid or gaseous state.

A further application entails using the connecting device as a single-use item or on a batch basis and disposing of said device thereafter. In the case of a single use, at least the connecting ring is disposed of after one connecting and detaching operation, whereas, when used on a batch basis, a plurality of second line ends are connected to the same first line end. Batch use is said to apply, for example, if a reactor needs to be filled with a quantity of a substance which cannot be provided using a single sack but requires a plurality of sacks to be emptied. As a result, a plurality of second line ends, which are in each case connected to a sack, in which the substance is stored and transported, are connected to the first line end using the connecting ring. As soon as the required quantity of substance has been transferred into the reactor, the connecting ring is disposed of.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

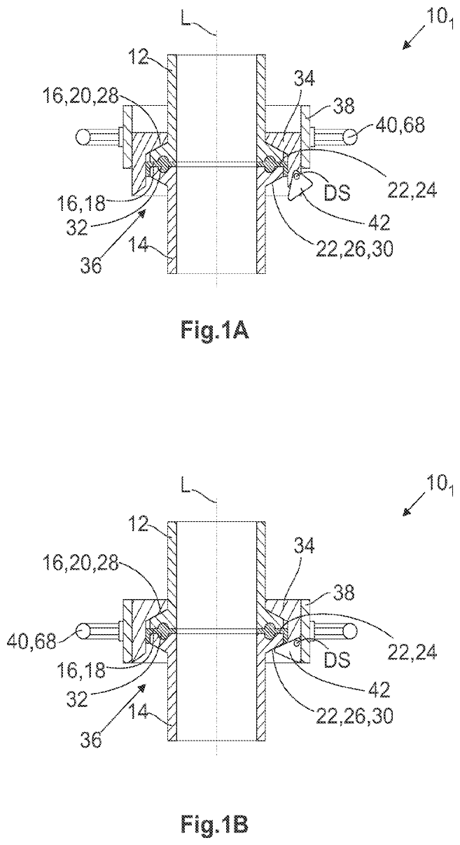

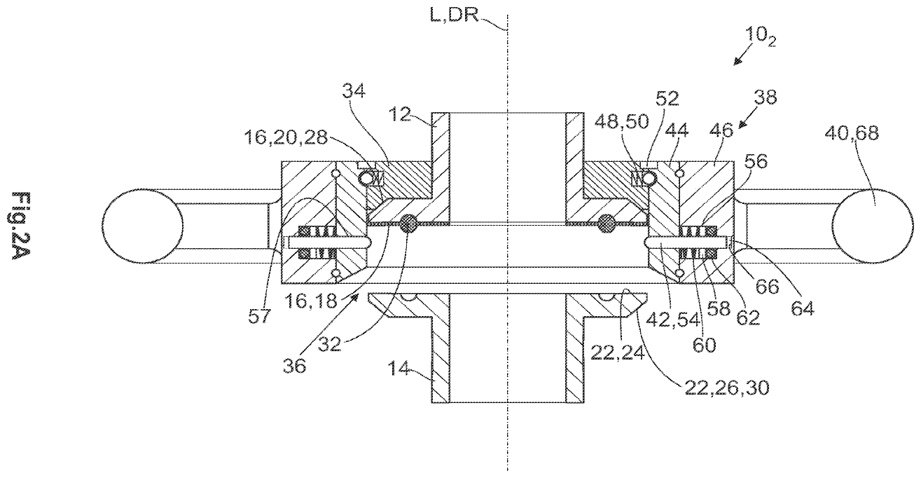

FIG. 1A shows a first embodiment of a connecting device 10₁ for connecting a first line end 12 to a second line end 14 by means of an outline sectional view. The first line end 12 may, for example, be the end of a pipe or a hose. The same applies to the second line end 14. The pipes or hoses can be connected to a container or a port, for example a supply port (not shown).

The first line end 12 has a flange-like radial first widening 16 with a first end face 18 and a first rear face 20. The second line end 14 is designed accordingly and as a result comprises a flange-like radial second widening 22 with a second end face 24 and a second rear face 26. It is evident that the first rear face 20 and the second rear face 26 are inclined with respect to the first end face 18 or the second end face 24 respectively such that the first line end 12 comprises a first inclined surface 28 and the second line end 14 comprises a second inclined surface 30. It is also evident that a sealing element 32 is in this case attached to the second line end 14, attachment to the first line end 12 also being possible. The first line end 12 and the second line end 14 are designed such that they can be connected to one another using a commercially available tri-clamp.

The connecting device 10₁ comprises a support ring 34 which can be brought into contact with the first rear face 20. In this case, the support ring 34 can be designed as a form of clamping set such that the support ring 34 can be fixed axially to the first line end 12 so that it cannot rotate. As mentioned, the first rear face 20 is designed as the first inclined surface 28 such that the support ring 34 also has a contact surface aligned correspondingly with respect to the first inclined surface 28. As can also be seen on FIG. 1A, the support ring 34 protrudes radially outwards over the first widening 16 and the second widening 22. In addition, the support ring 34 protrudes over the first end face 18 if the support ring 34 has been brought into contact with the first rear face 20. As a result of this configuration, the support ring 34 forms a receiving opening 36 into which the second line end 14 can be inserted with its second widening 22, as shown in FIG. 1A. In this case, the first line end 12 and the second line end 14 define a longitudinal axis L, with respect to which the support ring 34 is concentrically arranged.

Furthermore, the connecting device 10₁ comprises a locking device 38, which is designed to be annular in the first embodiment and has a female thread. The locking device 38 can accordingly be screwed onto the support ring 34 and positioned coaxially with respect to the longitudinal axis L, wherein the support ring 34 comprises a correspondingly designed male thread, the female thread and the male thread not being shown in greater detail in FIG. 1A. In order to rotate the locking device 38, said device comprises a handle 40, which is designed in the form of a hand wheel 68. Accordingly, a user can rotate the locking device 38 in a simple manner and thus screw it onto the support ring 34.

Furthermore, a locking body 42 is provided which is attached to the support ring 34 in the first embodiment. The locking body 42 is attached to the support ring 34 in such a way that it can be rotated around an axis of rotation DS running perpendicular to the longitudinal axis L, wherein the locking body 42 is attached to the support ring 34 in the vicinity of the receiving opening 36 and is thus arranged in front of the first end face 18 when viewed from the first rear face 20. The axis of rotation DS runs eccentrically through the locking body 42, which, in the first embodiment, referred to the plane of representation defined by FIG. 1A, has an approximately triangular cross-section. The locking body 42 is mounted such that it is able to interact with the locking device 38 whatever the position of said locking device. In FIG. 1A, the locking device 38 is in an open position in which it does not interact with the locking body 42. As a result, the locking body 42 can rotate in a substantially unrestricted manner around its axis of rotation DS. Consequently, the second line end 14 can be inserted into the receiving opening 36 without the locking body 42 getting in the way in this process.

The second line end 14 is inserted sufficiently far into the receiving opening 36 in this case until the first end face 18 comes into contact with the sealing element 32. The support ring pre-positions the second line end 14 until it is aligned axially flush with the longitudinal axis L of the first line end 12. The locking device 38 is then rotated around the longitudinal axis L, causing it to undergo an axial movement along the longitudinal axis L, which is directed downwards with respect to FIG. 1A. In this process, the locking device 38 comes into contact with the locking body 42 with effect from a certain position and in the process in turn rotates the locking body 42 in a clockwise direction around its axis of rotation DS with reference to the representation selected in FIG. 1A. Due to its eccentric mounting, part of the locking body comes into contact with the second rear face 26 and applies a clamping force to the second rear face 26, which is directed at least in part along the longitudinal axis L and towards the first end face 18. Consequently, the second line end 14 is pressed against the first end face 18 of the first line end 12, causing the sealing element 32 to be compressed. The locking body 42 is now in a closed position. The first line end 12 and the second line end 14 are now connected to one another in a sealing manner, as shown in FIG. 1B, such that fluids, particulate solids or similar can be conveyed from the first line end 12 to the second line end 14 and vice versa.

In order to detach the second line end 14 from the first line end 12, the locking device 38 is moved into a position such that said device no longer interacts with the locking body 42, for example into the position illustrated in FIG. 1A.

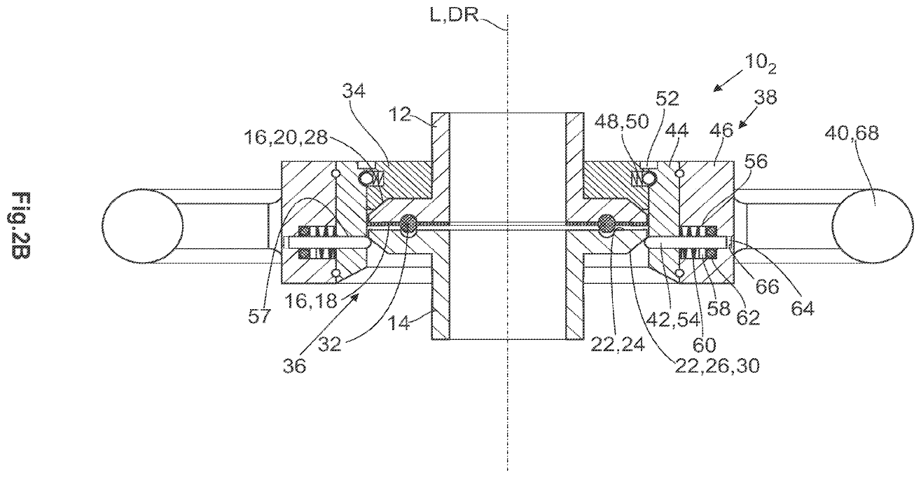

FIG. 2A to 2C show a second embodiment of the connecting device 10₂, also by means of outline sectional views. In this case, the first line end 12 and the second line end 14 are substantially designed in the same way as the embodiment illustrated in FIGS. 1A and 1B, which means that the relevant description can be referred to. Also in this case, the connecting device 10₂ comprises the aforementioned support ring 34, which can be brought into contact with the first rear face 20 of the first line end 12, as is also shown in FIG. 2A. However, the support ring 34 protrudes only very slightly over the first widening 16 in the radial direction. The locking device 38 also comprises a first ring 44 and a second ring 46 in this case. The second ring 46 is attached to the first ring 44 such that it can rotate around the first ring 44 around an axis of rotation DR without the second ring 46 being able to be moved in the axial direction in this process. The axis of rotation DR coincides with the longitudinal axis L of the first line end. The first ring 44 can be detachably connected to the support ring 34. A latch connection 48 with correspondingly designed latching means 50 is provided for this purpose such that the first ring only needs to be pushed onto the support ring 34 until the latching means 50 creates a positive connection between the first ring 44 and the support ring 34. Furthermore, an anti-rotation device 52 is provided to ensure that the first ring 44 is unable to rotate around the support ring 36. The first ring 44 and the second ring 46 are arranged concentrically with respect to the longitudinal axis L.

The aforementioned locking body 42 is in this case mounted in the locking device 38 and designed as a locking pin 54. The locking pin 54 can be displaced axially in a blind hole 56 of the second ring 46 and passes through a hole 57 in the first ring 44. The locking pin 54 comprises a collar 58 on which a first pre-tensioning means 60 and a second pre-tensioning means 62 are supported. The first pre-tensioning means 60 is also supported on the first ring 44, while the second pre-tensioning means 62 is supported on the bottom of the blind hole 56. While the first pre-tensioning means 60 is designed as a spring, the second pre-tensioning means 62 is constructed as a flexible O-ring.

Furthermore, the locking pin 54 protrudes into a groove 64 which extends by a certain amount in the circumferential direction of the second ring 46 and forms an adjustment surface 66 on the bottom of said groove. The distance between the adjustment surface 66 and the longitudinal axis L varies in the circumferential direction of the groove 64.

The first pre-tensioning means 60 is designed such that it pre-tensions the locking pin 54 with respect to the adjustment surface 66 while the second pre-tensioning means 62 pre-tensions the locking pin 54 radially inwards.

In FIG. 2A the connecting device 10₂ is in an initial position. In this initial position, the second line end 14 has not yet been inserted into the receiving opening 36, which is in this case formed by the first ring 44. The locking pin 54 is not yet in contact with the adjustment surface 66 in this case and can therefore still be moved radially outwards to a certain extent. In FIG. 2B the second line end 14 is inserted in the receiving opening 36, wherein the locking pin 54 abuts the second inclined surface 30. When inserting the second line end 14 into the receiving opening 36, the second widening 22 comes into contact with the locking pin 54 and moves said pin radially outwards until the locking pin 54 does not block the axial movement of the second line end 14. In this process, the second pre-tensioning means 62 is compressed, as a result of which a resetting force, directed radially inwards, is generated. As soon as the second line end 14 is moved sufficiently far towards the first line end 12 that the diameter of the second widening 22 in the vicinity of the second inclined surface 30 becomes smaller, the locking pin 54 is once again displaced radially inwards due to the resetting force of the second pre-tensioning means 62, wherein the locking pin 54 is able to come into contact with the second inclined surface 30. In the position shown in FIG. 2B, as a result, the second line end 14 is held by the locking pin 54 in the position shown therein, but the second line end 14 does not yet fully abut the sealing element 32, with the result that there is as yet no sealing connection between the first line end 12 and the second line end 14. However, the relevant person can remove their hand from the second line end 14 and grip the handle 40 to rotate the second ring 46. As mentioned, the distance between the adjustment surface 66 and the longitudinal axis L varies in the circumferential direction of the groove 64. The second ring 46 is now rotated such that the distance between the adjustment surface 66 and the longitudinal axis L in the vicinity of the locking pin 54 becomes smaller. Consequently the locking pin 54 comes into contact with the adjustment surface 66 beyond a certain rotation position of the second ring 46. The further the second ring 46 is rotated, the further the locking pin 54 moves radially inwards and is pressed against the second inclined surface 30. In this process, the locking pin 54 transfers a proportion of the force directed along the longitudinal axis L onto the second inclined surface 30, as a result of which the second line end 14 is displaced towards the first end face 18 of the first line end 12. In this case the second end face 24 comes into sealing contact with the sealing element 32, with the result that the first line end 12 and the second line end 14 are connected to one another in a sealing manner. The locking pin 54 is now in the closed position (see FIG. 2C).

Due to the movement of the locking pin 54, which is directed radially inwards, the first pre-tensioning means 60 is compressed and, as a result, said means exerts a resetting force directed radially outwards. Due to contact between the locking pin 54 and the adjustment surface 66, the locking pin 54 remains in the position shown in FIG. 2C so that the second line end 14 can no longer be displaced axially relative to the first line end 12.

In order to detach the second line end 14 from the first line end 12 again, the second ring 46 is rotated in the opposite direction. Due to the resetting force generated by the first pre-tensioning means 60, this ensures that the locking pin 54 is also pressed against the adjustment surface 66 when rotating the second ring 46. As the distance between the adjustment surface 66 and the longitudinal axis L becomes larger in this case, the locking pin 54 moves radially outwards. As a result, the second line end 14 is released and can be detached from the first line end 12.

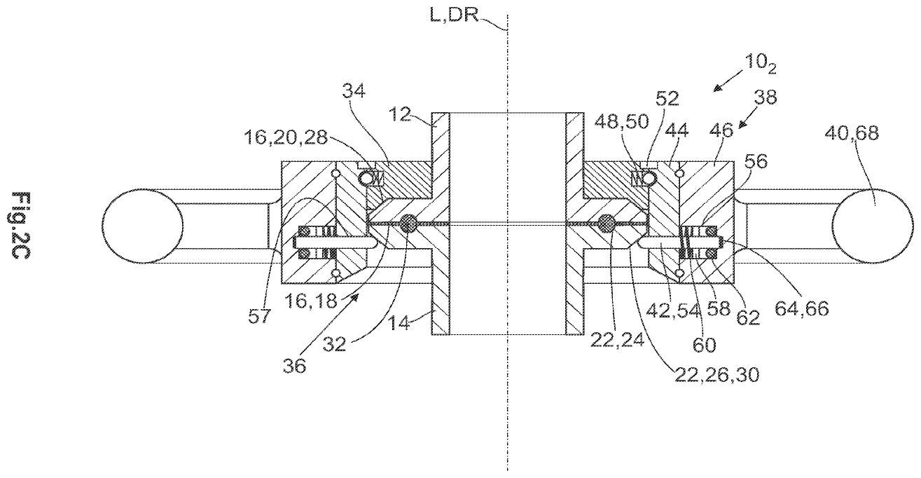

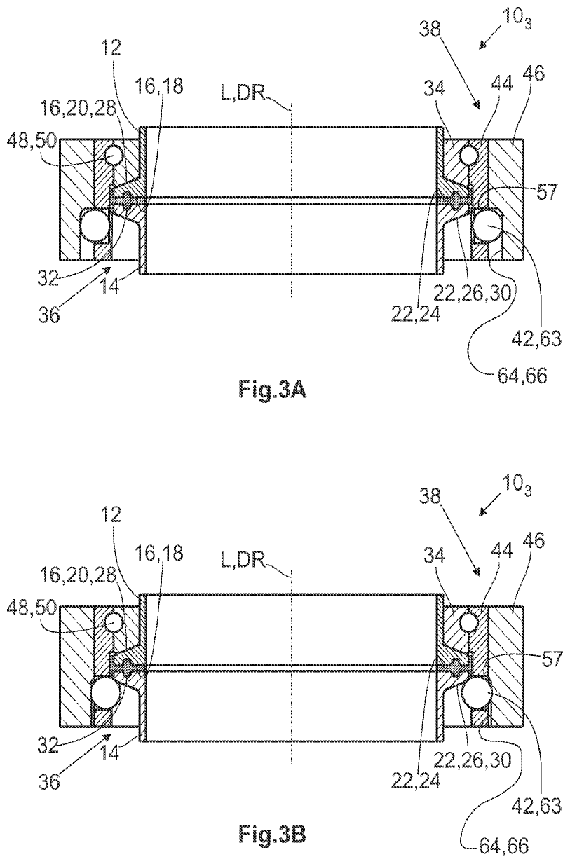

In FIGS. 3A and 3B a third embodiment of the connecting device 10₃ is shown in a sectional view, wherein the second line end 14 is pre-positioned in FIG. 3A, while in FIG. 3B the first line end 12 and the second line end 14 are connected to one another. The connecting device 10₃ according to the third embodiment is designed to be similar to the connecting device 10₂ according to the second embodiment, with the result that only the key differences are mentioned below. The locking body 42 is designed as a locking ball 63, which is mounted, like the locking pin 54 of the second embodiment of the connecting device 10₂, in a hole 57 in the first ring 44. Likewise, in this embodiment, the second ring 46 comprises the aforementioned groove 64, on the bottom of which the adjustment surface 66 is formed. The distance between the adjustment surface 66 and the axis of rotation DR of the second ring 46 varies in the circumferential direction of the groove 64. The locking ball 63 abuts the adjustment surface 66. If the second ring 46 is rotated, the locking ball 63 moves radially inwards and is pressed against the second inclined surface 30. In this process, the locking ball 63 transfers a proportion of the force directed along the longitudinal axis L onto the second inclined surface 30, as a result of which the second line end 14 is displaced towards the first end face 18 of the first line end 12. In this case the second end face 24 comes into sealing contact with the sealing element 32, with the result that the first line end 12 and the second line end 14 are connected to one another in a sealing manner. The locking ball 63 is now in the closed position (see FIG. 3B).

In order to detach the first line end 12 from the second line end 14, the second ring 46 is once again rotated back into the position shown in FIG. 3A. If the second line end 14 is moved away from the first line end 12, the locking ball 63 is pressed radially outwards and releases the way for the second line end 14 so that the second line end 14 can be removed from the receiving opening 36.

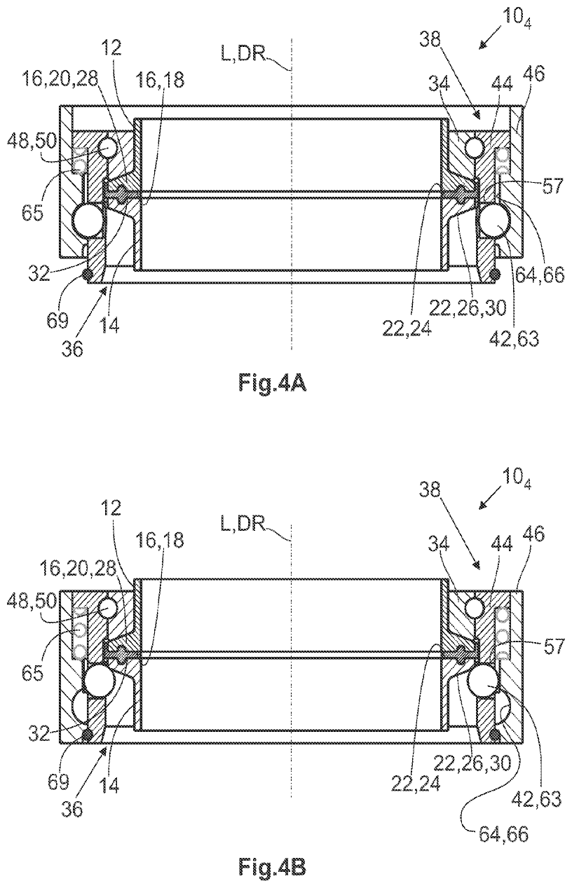

FIGS. 4A and 4B show a fourth embodiment of the connecting device 10₄ by means of a sectional view, wherein the second line end 14 is pre-positioned in FIG. 4A, while in FIG. 4B the first line end 12 and the second line end 14 are connected to one another. Likewise, in this embodiment the locking body 42 is designed as a locking ball 63, which is mounted in a hole 57 in the first ring 44. In this embodiment, the second ring 46 can be moved axially with respect to the first ring 44 and is pre-tensioned in the position shown in FIG. 4B with a spring 65. In order to define this position, a stop element 69 is provided on the first ring 44, with which the axial mobility of the second ring 46 is limited. The second ring 46 is also furnished with the groove 64 in this embodiment, although the distance between the adjustment surface 66 and the axis of rotation DR does not vary in the circumferential direction, but it does vary in the axial direction. In this case, the second ring 46 does not necessarily need to be attached to the first ring 44 such that it can rotate. In this respect, the term “axis of rotation” DR should be understood in the geometrical sense and not in functional terms. If the second ring 46 is in the position shown in FIG. 4B, the locking ball 63 is pressed against the second inclined surface 30 such that the second line end 14 is pressed against the first line end 12. The locking ball 63 cannot move radially outwards with the result that the second line end 14 can no longer be displaced axially in relation to the first line end 12.

In order to detach the second line end 14 from the first line end 12 again, the second ring 46 is displaced against the pre-tensioning force of the spring 65 into the position shown in FIG. 4A, in which the radial distance between the adjustment surface 66 and the axis of rotation DR in the vicinity of the locking ball 63 increases and becomes large enough for the locking ball 63 to deflect radially outwards sufficiently to permit the second line end 14 to be released and be able to be detached from the first line end 12.

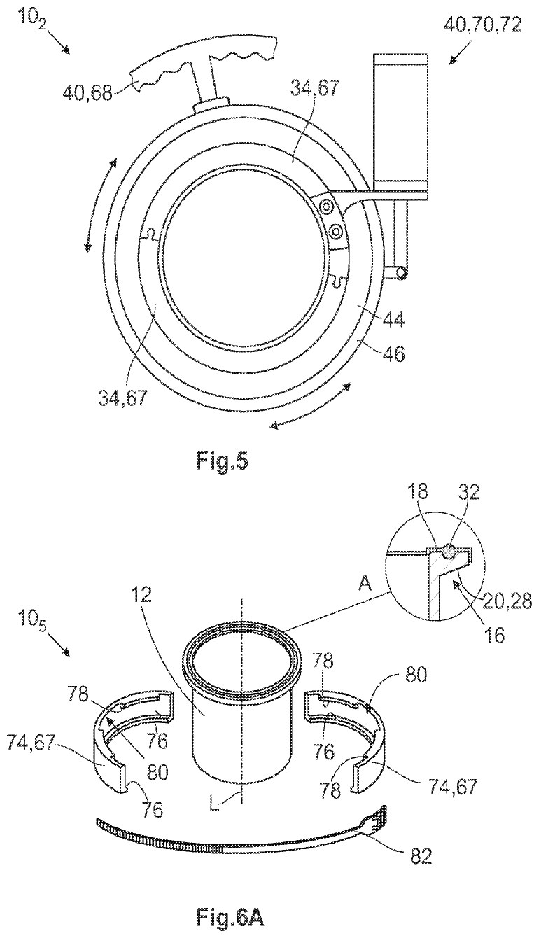

FIG. 5 shows an outline plan view of the second embodiment of the connecting device 10₂ shown in FIG. 2A to 2C. It is evident that the support ring 34 is formed by two ring segments 67, which are identical in design and can be connected together in a form-locking manner. As mentioned above, the support ring 34 ends more or less flush in the radial direction with the first widening 16 such that the first ring 44 can be pushed on the support ring 34 without coming into contact with the first widening 16 during this process. As a result, irrespective of whether the first line end 12 is part of a line that is securely connected to a component, in particular to a container, the first ring 44 can be pushed over the first widening 16. If, however, the line connected to the first line end 12 is securely connected to a container or similar, it is not possible to arrange a one-piece support ring 34, viewed from the first end face 18, behind the first widening 16 such that the support ring 34 can be brought into contact with the first rear face 20. However, using a two-part or multi-part support ring 34 forming ring segments 67 makes this arrangement possible.

Furthermore, FIG. 5 shows the handle 40 which is designed as a hand wheel 68, only part of which is illustrated. In addition, a drive unit 70 is attached to the support ring 34, by means of which drive unit it is possible to rotate the second ring 46 around the longitudinal axis L in an automated manner. In the embodiment shown, the drive unit 70 comprises a piston-cylinder unit 72, which may, for example, be actuated by pneumatic or hydraulic means.

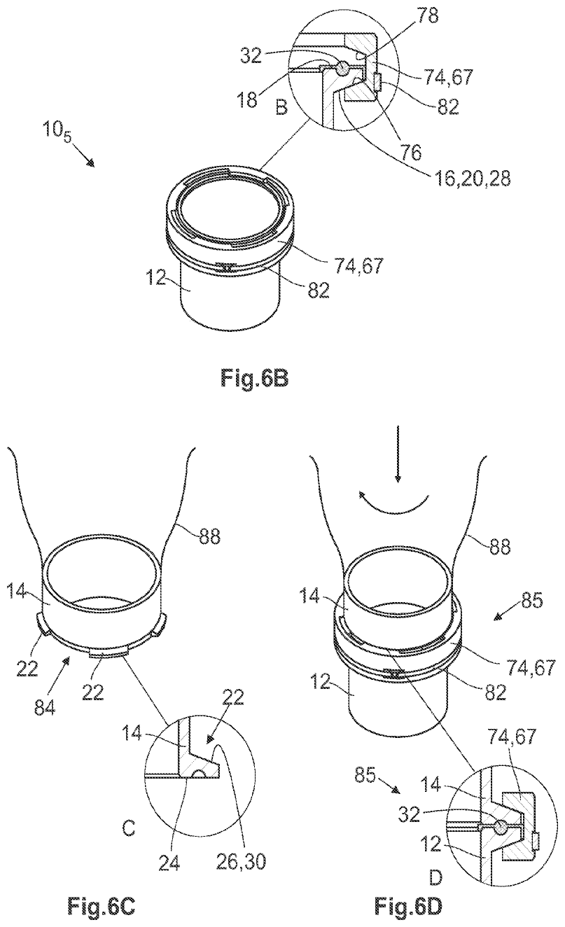

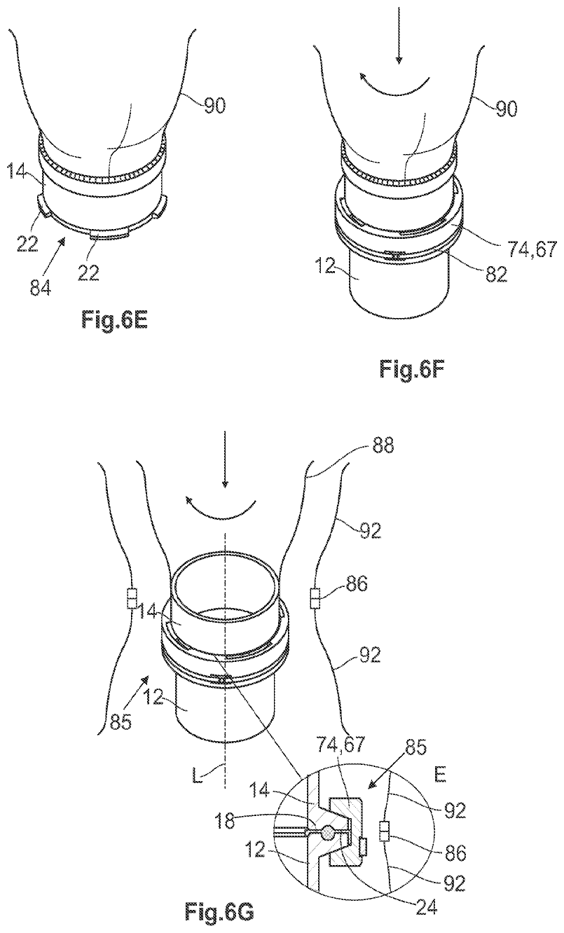

FIG. 6A to 6G show a fifth embodiment of a proposed connecting device 10₅ in various states, wherein some of FIG. 6A to 6G comprise enlarged details A to E. FIG. 6A shows the connecting device 10₅ in an initial state. It also shows a first line end 12, which is designed in exactly the same way as the aforementioned first line ends 12, which can be used with a traditional tri-clamp. The first line end 12 in this embodiment also defines a longitudinal axis L (see FIGS. 6A and 6G). It is also evident in the enlarged detail A that, on the first end face 18, a sealing element 32 is connected to the first line end 12.

The connecting device 10₅ according to the fifth embodiment comprises a connecting ring 74, which, in the embodiment shown, is formed by two ring segments 67, which can be connected to one another by means of a cable tie 82, as shown in FIG. 6B. The connecting ring 74 has a radially uninterrupted peripheral first closure face 76, which is designed to correspond to the first inclined surface 28 of the first widening 16 of the first line end 12. Furthermore, the connecting ring 74 has a number of second closure faces 78, which are separated from one another by passage portions 80 designed in the form of a recess. The second closure faces 78 have the same inclination as the first closure faces 76, as is particularly evident from the enlarged detail B in FIG. 6B.

FIG. 6C shows a second line end 14, which has a number of second widenings 22, wherein the second widenings 22 are separated from one another by interruption portions 84, which are also designed in the form of a recess. Moreover, the second widenings 22 are designed in exactly the same way as the second widenings 22 described previously.

The first line end 12, the second line end 14 and the connecting device 10₅ together form a connecting arrangement 85. An embodiment of the connecting arrangement 85, in which the first line end 12 has a plurality of first widenings 16, which are separated from one another by interruption portions 84, is not shown. In this embodiment of the connecting arrangement, the first line end 12 and the second line end 14 may have identical designs. However, the connecting ring 74 may remain unchanged. However, it is equally possible to provide the connecting ring 74 with a plurality of first closure faces 76, which are separated from one another by passage portions 80 (not shown). In this case, the connecting ring 74 may be constructed symmetrically with respect to a plane of symmetry which runs perpendicular to the longitudinal axis L.

In order to connect the second line end 14 to the first line end 12, the connecting ring 74 is first connected to the first line end 12 using the cable tie 82, as illustrated in FIG. 6B. The second line end 14 is then arranged coaxially with respect to the first line end 12, wherein the second line end 14 is moved into a rotation position in which the second widenings 22 can be passed axially through the passage portions 80 of the connecting ring 74. As soon as the second widenings 22, viewed axially, are located behind the second closure faces 78 of the connecting ring 74, the second line end 14 and/or the connecting ring 74 are rotated around the longitudinal axis L such that the second rear faces 26 of the second widenings 22 can be brought into contact with the two closure faces 78 of the connecting ring 74. The first line end 12 and the second line end 14 are accordingly connected to one another in the form of a bayonet closure.

Both the two closure faces 78 and the second rear faces 26 may in this case be slightly inclined in the circumferential direction and therefore designed in the form of ramps. This means that, when rotating the second line end 14, said end is also displaced axially towards the first line end 12 such that a sealing contact is achieved between the second end face 24 and the sealing element 32, as shown in FIG. 6D. As a result, the first line end 12 and the second line end 14 are connected to one another in a sealing manner.

FIGS. 6C and 6D show that a flexible sheath 88 is connected to the second line end 14. FIGS. 6E and 6F show a different design of sheath 90 connected to the second line end 14. It is also possible to connect quite different components using the connecting device 10₁ with the standardised first line end 12.

FIG. 6G shows the first line end 12 shown in FIG. 6D and the second line end 14 or the connecting arrangement 85 respectively in the connected state, wherein a secondary interface 86 is arranged radially outside the connecting device 10₅ or the connecting arrangement 85 respectively. The secondary interface 86 connects two tubular protective sheaths 92, thus making it possible to prevent a substance that is intended to pass from the first line end 12 or the second line end 14 in the region of the connecting device 10₅ from passing into the environment in an uncontrolled manner. The secondary interface 86 and the protective sheaths 92 can also be used in the same way for the connecting devices 10₁ to 10₄ according to the first embodiment to the fourth embodiment.

### LIST OF REFERENCE NUMERALS

10 connecting device
10₁-10₅ connecting device
12 first line end
14 second line end
16 first widening
18 first end face
first rear face
22 second widening
24 second end face
26 second rear face
28 first inclined surface
30 second inclined surface
32 sealing element
34 support ring
36 receiving opening
38 locking device
40 handle
42 locking body
44 first ring
46 second ring
48 latch connection
50 latching means
52 anti-rotation device
54 locking pin
56 blind hole
57 hole
58 collar
60 first pre-tensioning means
62 second pre-tensioning means
63 locking ball
64 groove
65 spring
66 adjustment surface
67 ring segment
68 hand wheel
69 stop element
70 drive unit
72 piston cylinder unit
74 connecting ring
76 first closure face
78 second closure face
80 passage portion
82 cable tie
84 interruption portions
85 connecting arrangement
86 secondary interface
88 flexible sheath
90 sheath
92 protective sheath
A-E detail
DS axis of rotation, locking body
DR axis of rotation, second ring
L longitudinal axis

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single device, processor, module, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-12. (canceled)

13. A connecting device for connecting a first line end to a second line end, wherein
the first line end has a flange-like radial first widening with a first end face and a first rear face or
a plurality of flange-like radial first widenings each with a first end face and a first rear face, wherein the first widenings are separated from one another by interruption portions; and
the second line end has a plurality of flange-like radial second widenings each with a second end face and a second rear face, wherein the second widenings are separated from one another by interruption portions, and the connecting device comprises
a connecting ring with a first closure face or a plurality of first closure faces and a plurality of second closure faces, wherein the plurality of first closure faces and the plurality of second closure faces are separated from one another by passage portions; wherein
the first closure face can be brought into contact with the first rear face, or the first closure faces can be brought into contact with the first rear faces; and
the second closure faces can be brought into contact with the second rear faces by virtue of the fact that the second widenings are guided with an axial movement through the passage portions and then a relative rotational movement is carried out between the connecting ring and the first line end and/or a relative rotational movement is carried out between the connecting ring and the second line end.

14. The connecting device of claim 13, wherein the connecting ring is formed by two or more ring segments.

15. The connecting device of claim 14, wherein the ring segments can be connected to one another using a cable tie.

16. The connecting device of claim 13, wherein the second closure faces and/or the second rear faces are inclined in the circumferential direction.

17. The connecting device of claim 13, wherein the connecting ring is manufactured from a thermoplastics material.

18. The connecting device of claim 13, wherein the connecting ring is configured to complement a standard tri-clamp fitting.

19. The connecting device of claim 13, wherein the connecting device comprises a secondary interface, which encloses the connecting ring at a radial distance.

20. A method for connecting a first line end to a second line end using a connecting device, comprising:
bringing a first closure face of a connecting ring into contact with a first rear face of a first widening of the first line end;
passing second widenings of the second line end through passage portions of the connecting ring; and
bringing second closure faces of the connecting ring into contact with second rear faces of the second widenings of the second line end by a relative rotational movement between the connecting ring and the first line end and/or by a relative rotational movement between the connecting ring and the second line end.

21. A method for connecting a first line end to a second line end using a connecting device, comprising:
passing first widenings of the first line end through passage portions of a connecting ring;
bringing first closure faces of the connecting ring into contact with first rear faces of the first widenings of the first line end by a relative rotational movement between the connecting ring and the first line end;
passing second widenings of the second line end through passage portions of the connecting ring; and
bringing second closure faces of the connecting ring into contact with second rear faces of the second widenings of the second line end by a relative rotational movement between the connecting ring and the second line end.

22. A connecting arrangement for connecting a first line end to a second line end (14) using the connecting device of claim 13, comprising:
the first line end and the second line end and
the connecting ring; wherein
the first line end and the second line end are connectable to one another with the connecting ring.

23. The connecting arrangement of claim 22, wherein the first line end and/or the second line end are manufactured from a thermoplastics material.

24. The connecting arrangement of claim 22, wherein the first line end and/or the second line end are configured as a standard tri-clamp fitting.

25. The connecting device of claim 14, wherein the second closure faces and/or the second rear faces are inclined in the circumferential direction.

26. The connecting device of claim 15, wherein the second closure faces and/or the second rear faces are inclined in the circumferential direction.

27. The connecting device of claim 14, wherein the connecting ring is manufactured from a thermoplastics material.

28. The connecting device of claim 15, wherein the connecting ring is manufactured from a thermoplastics material.

29. The connecting device of claim 16, wherein the connecting ring is manufactured from a thermoplastics material.

30. The connecting device of claim 14, wherein the connecting ring is configured to complement a standard tri-clamp fitting.

31. The connecting device of claim 15, wherein the connecting ring is configured to complement a standard tri-clamp fitting.

32. The connecting device of claim 16, wherein the connecting ring is configured to complement a standard tri-clamp fitting.
